(19) United States
(12) Patent Application Publication
(10) Pub. No.: US 2014/0200835 A1
(43) Pub. Date: Jul. 17, 2014

(54) Pedaling Torque Sensor Device for Each Cyclist's Leg and Power Meter Apparatus

(71) Applicant: Pablo Carrasco Vergara, Madrid (ES)

(72) Inventor: Pablo Carrasco Vergara, Madrid (ES)

(21) Appl. No.: 14/234,410

(22) PCT Filed: Jul. 23, 2012
(86) PCT No.: PCT/EP2012/064432

§ 371 Date: Mar. 25, 2014

(30) Foreign Application Priority Data
Aug. 2, 2011 (ES) P201100881

(51) Int. Cl. G01L 3/10

(52) U.S. Cl. CPC G01L 3/10
USPC 702/42

(57) ABSTRACT

Pedaling torque sensor device for bicycles comprising a crank arm (1) performed in a single-piece element having a cross section closed and symmetrical about a plane of symmetry (10) and also symmetric about the plane which is orthogonal to said plane (10) containing the main longitudinal axis of the crank arm (7). Said crank arm (1) is provided with at least one couple of straight drilled blind holes (5, 6) respectively symmetric about the mentioned plane of symmetry (10), and each one of the mentioned strain gauges (2) are non-detachably fixed on the inside of the crank arm (1) within 10 the straight drilled blind hole (5, 6) walls.

It is also object of the invention a power meter apparatus (40) to calculate jointly and separately the instantaneous power delivered for each cyclist's leg, comprising two of the aforementioned pedaling torque sensor devices, means to measure the instantaneous angular velocity of the crankset and a power meter CPU (35) that integrates and processes the signals received.

In the field of bicycles, the present invention relates to a measuring device for the torque and the power that a cyclist generates with each single leg when pedaling, which helps to analyze the involvement of different groups of muscles and the possible asymmetries between the two legs, not only in the laboratory but also as a standalone on one's bike, improving the quality of training and sports performance.

### PRIOR ART

There are several systems measuring either forces or applied torque by the cyclist, and therefore are also able to measure the power when the speed or the corresponding angular velocity is known.

Systems being implemented on cycling obtain the data torque, often based on the use of strain gauges, by measuring the elastic deformation in some of the drivetrain system components caused by mechanical loads introduced by the cyclist pedaling. The torque calculated in the bottom bracket spindle multiplied by the crankset rotational speed is the instantaneous power. Whereas, the speed of the crankset is approximately constant on each revolution, the pedaling cadence could be enough to estimate the instantaneous angular velocity data and so to estimate the instantaneous power value as a result of the product of these torque and angular velocity values.

The most common component for measuring the elastic deformation and therefore the torque is usually the spider supporting the chainrings. Other systems measure deformation on the bottom bracket spindle, the chain, the rear wheel hub and so on. In the case of measurement on the bottom bracket spindle, the torque data is obtained just from a single leg, which corresponds to the non drive side.

However, based on the total power produced by the cyclist, you lose important information about the biomechanics of cycling, as it is important to know how you are working with each leg and the way this work is; for example the way you pedal during the rising phase of your legs, or how uniform is the applied force.

Laboratories already work with the data of each leg separately, sometimes using two conventional spider-based power meters and two chains, one for each of the legs of the cyclist. In addition, individualized torque and power measurement systems per leg have been based on the instrumentation of the pedals, the crank arms or even fitting in the cyclist's shoes insoles with pressure sensors, the latter being very inaccurate when trying to know the effective force applied to each pedal.

In recent years, several leading brands in monitoring sports in general and cycling in particular, have shown future torque or power measurement products based on sensors mounted on pedal shafts: such as company Metrigear specialized measurement tools for athletes, acquired by Garmin, a leader in portable navigation solutions that have created a system to measure the power of a cyclist while pedaling through two separate sensors that are placed on both pedal shafts, as anticipated in the document US2010/0024590; and also the company Polar in alliance with Look described in the patent FR2878328A1.

Considering these systems have not yet reached the market after the time elapsed since they were respectively announced, it makes sense to imagine how complex measurement system based on the pedals are, especially considering that many of the forces applied on the pedals are not generating torque and therefore do not generate power. So, it is reasonable to think that data for deflection in the axis of each pedal, need error correction algorithms depending on different maps of use because a force applied to the pedal in the tangential direction of the displacement, generates bending deflection in the axis of the pedal and does generate torque; but now bending moment applied to the pedal and aligned with the crank (for example balancing the bike from side to side when pedaling standing) also produce bending deflection in the axis of the pedal, but this does not correspond to a torque generation. For these reasons, plus the complexity added to such small space, and its sensitive location as exposed to potential impacts, we consider that the measurement systems on the pedals are not appropriate for a product capable of reaching the market and achieve reliable measurements with a solid product.

Finally, there are some systems that obtain the torque applied by the cyclist by measuring the elastic deformation of each crank arm during pedaling by placing several strain gauges in the cranks. So far, the problem of these systems is the bulkiness or simply the exposure to hits and scrapes and in addition, the added complexity in the electronics necessary to obtain the torque from local deformation data measured by multiple gauges. Therefore, their application has focused on cycle ergometer and laboratory bicycles, such as AIP Studio MEP cranks whose description we can see in the document WO2011030215.

### SUMMARY OF THE INVENTION

The present invention relates to a pedaling torque sensor device consisting in a bicycle crank arm which is instrumented in its inside in order to know its deflection in the pedaling plane, therefore knowing directly the torque generated by the corresponding single leg of a cyclist.

This pedaling torque sensor device is then used for the construction of a power meter apparatus for bicycles.

Said torque sensor is based in a crank arm which is symmetrical about the plane containing the bottom bracket axis and the pedal axis. This crank arm has two straight holes respectively symmetric about said plane, with these two holes executed just at the end of the crank arm corresponding to the bottom bracket axis, so that these holes configure two longitudinal cavities inside said crank arm.

These holes accommodate one or more strain gauge sets on their internal walls, being the location of these gauges symmetric about the plane containing the bottom bracket axis and the pedal axis.

To function, this instrumented crank arm is necessarily connected to an electronic module whose mission is to transform the strain gauges deformation, reproducing local deformation, into electrical signal. Due to the symmetrical disposition of the gauges in this instrumented crank arm, and once electrically connected in opposed configuration, it is achieved that only in the case of measurements of opposite deformations will result in an output signal. So this configuration of the gauges only responds to deflections of the crank in the working direction of the crank arm, i.e. orthogonal to the longitudinal axis of the crank arm and included in the plane of symmetry, giving null values for all the other crank efforts: traction-compression, torsion (along its longitudinal axis) and lateral deflection (normal to the plane of symmetry), obtaining directly from the electronic module a linear output signal which is proportional to the value of the crank bending moment according to its working direction. And inasmuch as this direction is, for the geometric nature of the crank arms, practically coincident with the bottom bracket axis, the bending moment measured by the sensor according to the invention accurately approximates the torque exerted by the cyclist's leg in the bottom bracket axis.

This eliminates the need of electronic corrections or computer programming which have some of the torque measuring systems included in the Prior Art, to transform the data collected by the corresponding sensors, because in the case of the present invention said deflection value is obtained without further conversion than the necessary homothety to change the measured data units following a previous calibration process for this pedaling torque sensor device.

Technical problems existing in the Prior Art that solves the pedaling torque sensor device according to the invention derive from this geometric configuration and are both structural and functional. Structurally because in order to house the gauges, it is based in a conventional crank arm, in use and proportions, thus keeping the weight and the mechanical rigidity of a crank arm suitable for use even in professional cycling, road and MTB (mountain bike); in addition, it gives total protection against external elements to the area equipped with gauges, avoiding therefore the bulkiness, excess weight and volume of other setting-up. On the other hand, functionally it achieves a direct ratio between the input and the output, i.e. between torque and electric signal, which helps to have a high accuracy in the measurement while a lower electric power consumption in the batteries needed for operation.

It is also object of the present invention a power meter apparatus comprising both torque sensors with the corresponding electronic modules as described above, means for measuring or estimating the instantaneous angular velocity of the crankset and a power meter CPU responsible to integrate the different signals received from the aforementioned sensors and means, in order to calculate the instantaneous power delivered by the cyclist's legs and to send this information via wireless signals to a computer, cycle computer, etc. The communication for said signals between the electronic modules, the power meter CPU and the means for measuring the instantaneous angular velocity of the crankset is preferred via wireless technology, therefore antennas and batteries will be comprised in these components.

As this power meter makes use of both pedaling torque sensor devices, it obtains the power data independently and continuously for each one of the cyclist's legs.

This not only makes it possible to calculate and display the percentage data for the power balance distributed between both legs, called BALANCE LEFT-RIGHT; but it also makes it possible to calculate and display the ratio between power delivered during the pedaling downstroke and power delivered during the rising phase of the pedal for each leg, called BALANCE PUSH-PULL, furthermore calculating this ratio for each leg and/or for both overall.

Finally, another aspect of the power meter apparatus according to the invention which is provided to the Prior Art, is an added utility for pedaling technique training, consisting in a warning mode by means of sound alerts or beeps, optionally activated by the cyclist: when this utility detects a negative torque from one of the cyclist's legs, produces a warning signal which may even be different for each leg.

### BRIEF DESCRIPTION OF THE FIGURES

FIG. 1 shows a pedaling torque sensor device comprising a bicycle crank arm (1) and indications for its most significant geometric elements: the bottom bracket axis (3), the pedal axis (4), the main longitudinal crank arm axis (7) and the longitudinal plane of symmetry of the crank arm (10).

FIG. 2 shows said pedaling torque sensor device comprising a crank arm (1) in side view and longitudinal section H-H′ along a plane orthogonal to its plane of symmetry (10) showing the two holes (5,6) along the crank arm, housing the strain gauges (2); also there is a central hole (8).

FIG. 3 is a perspective sectional view of a pedaling torque sensor device comprising a crank arm (1) and showing one of the strain gauges (2) housed therein, along with their electric wiring (20) to connect a corresponding electronic module (30).

FIG. 4 shows the cross section L-L′ of the pedaling torque sensor device comprising a crank arm (1) where we can see its symmetry about its two main axes and the holes made therein (5, 6, and 8).

FIG. 5 and FIG. 6 show a set of two pedaling torque sensor device comprising a crank arm (1) whit one of them fixed to the bottom bracket spindle (9), and wherein we can see the grooves (91) made in the bottom bracket spindle to allow passage of the electric wiring (20).

FIG. 7 shows one of the possible embodiments of the power meter apparatus (35) located attached to one of the pedaling torque sensor devices.

FIG. 8 shows a diagram of one possible configuration of the connections between the different elements of a complete system of measurement and electronic management of data collected by both pedaling torque sensor devices, corresponding electronic modules (30) and the angular position sensor (14) which send the data to the power meter apparatus (40) including a power meter CPU (35) to finally send them to a cycle computer (50) for processing, management, storage and/or displayed by the user.

### DETAILED DESCRIPTION OF A PREFERRED EMBODIMENT

A crank arm (1) is proposed which, in addition to its structural function of converting the forces exerted on the pedal coupled thereto in torque around the bottom bracket, becomes a sensor of said torque once it has been instrumented. This pedaling torque sensor device consists therefore in a special construction crank arm equipped internally with strain gauges (2), which are connected to a corresponding electronic module (30) to know its deflection in the pedaling plane and therefore directly the torque applied by each one of the cyclist's legs. In addition, we propose a power meter apparatus (40) comprising two aforementioned pedaling torque sensor devices

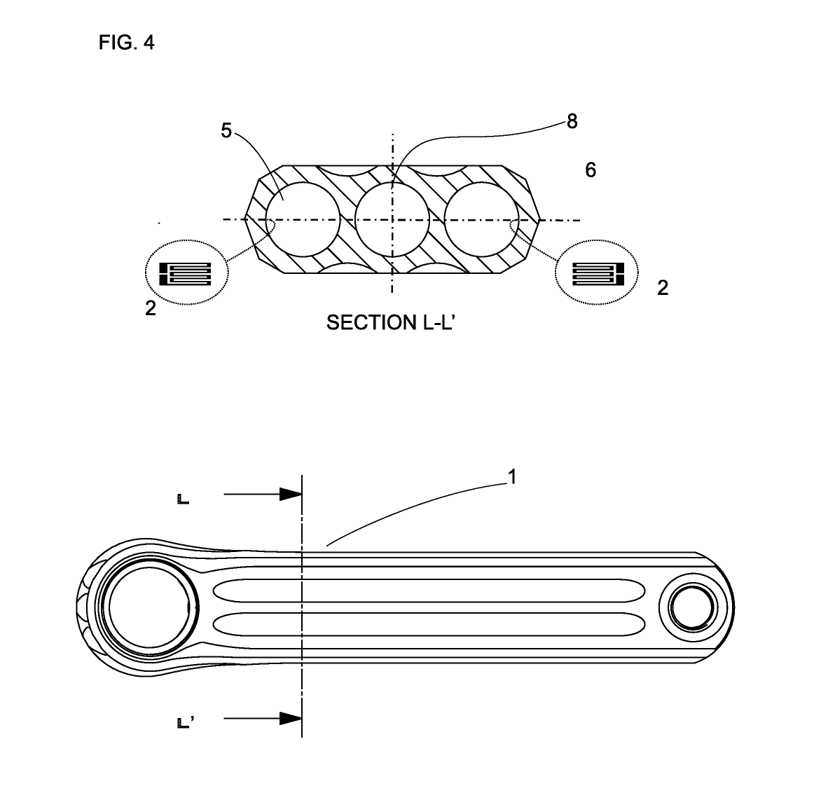

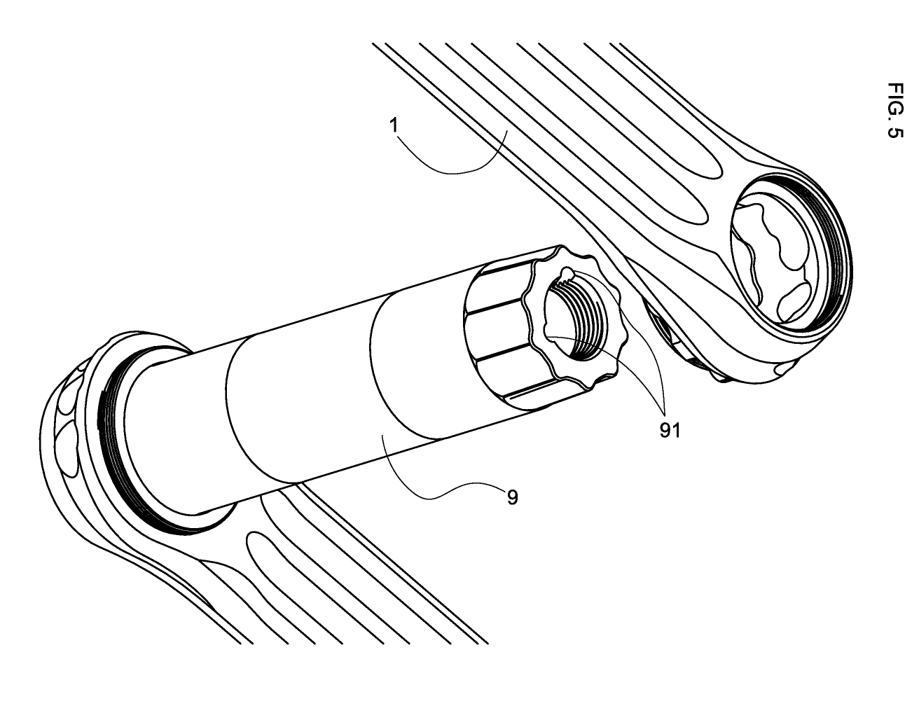

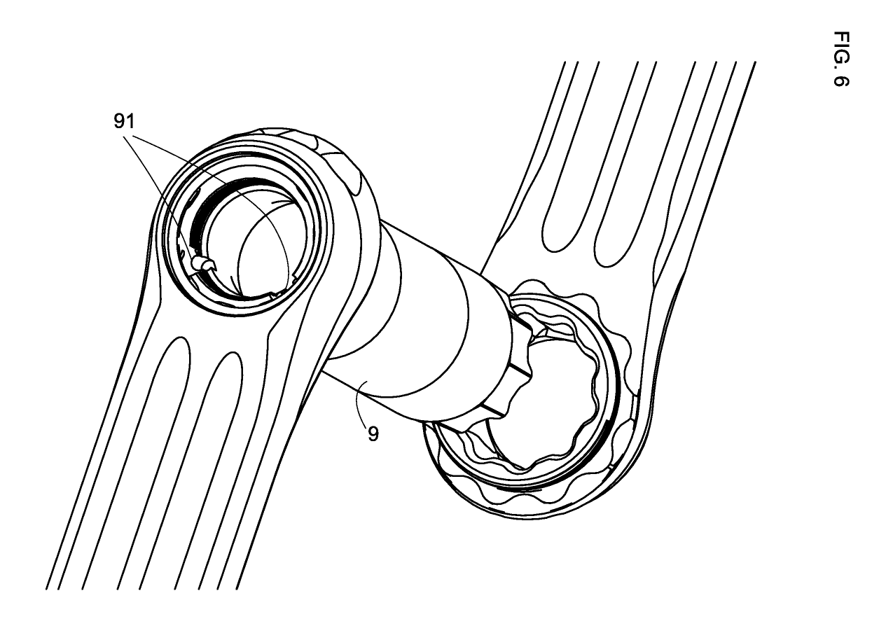

This pedaling torque sensor device for bicycles to measure the torque exerted in the direction of a bottom bracket axle by one cyclist's leg when operates a pedal, comprises a bicycle crank arm (1) performed in a tubular straight single-piece element, which connects said pedal with said bottom bracket, having a plane of symmetry (10) which contains the bottom bracket axis (3) and the pedal axis (4), and at least one couple of strain gauges (2) attached to said crank arm (1) for measuring the value of its bending moment in the direction of the bottom bracket axis (3) and being said gauges wiring (20) connected to an electronic module (30) able to send measured deflection data to a power meter CPU (35), characterized in that the cross section of said crank arm (1) is closed and symmetrical about the plane of symmetry (10) and It is symmetric about the plane which is orthogonal to said plane of symmetry (10) and also contains the main longitudinal axis of the crank arm (7); in addition, said crank arm (1) is provided with at least one couple of straight drilled blind holes (5, 6) respectively symmetric about the mentioned plane of symmetry (10), executed just at the end of the crank arm corresponding to the bottom bracket axis (3) so that these holes configure longitudinal cavities inside said crank arm (1) and are manufactured in a single-piece with the mentioned crank arm (1), resulting in a closed section which decrease the weight but maintains the mechanical rigidity and volume of the crank arm (1); besides, each one of the strain gauges (2) belonging to one couple of them, are non-detachably fixed on the inside of the crank arm (1) within the straight drilled blind hole (5, 6) walls, being the location of these gauges symmetric about the mentioned plane of symmetry (10). It is a metal crank symmetrical about the plane (10) containing the axes (3 and 4) which correspond respectively to the bottom bracket and the pedal, whose arm is straight and has two straight holes (5 and 6) respectively symmetric about said plane, with these two holes executed just at the end of the crank arm corresponding to the bottom bracket axis, so that these holes configure two longitudinal cavities inside said crank arm, such as the crank arm cross section, determined by the plane L-L′ (FIG. 4), is symmetrical about the two main axes of this cross section and it is constant along the crank arm. Preferably being the aforementioned straight holes (5.6) drilled. Each of these two holes houses one or more strain gauges (2) fixed on its walls, being the arrangement of such gauges symmetrical about said plane (10) containing the bottom bracket axis and the pedal axis.

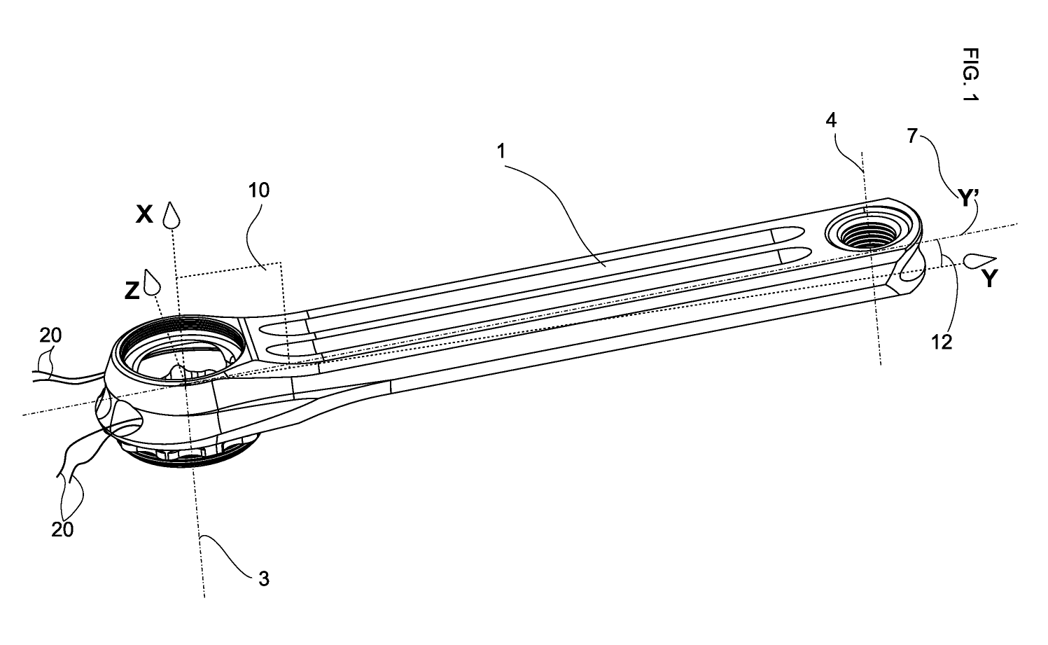

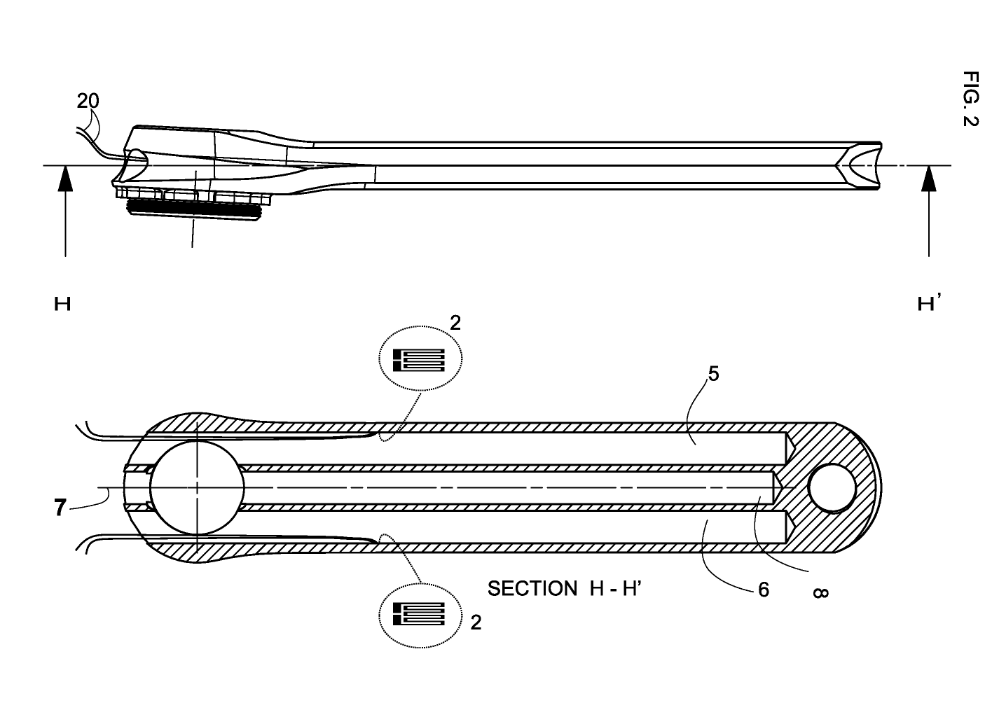

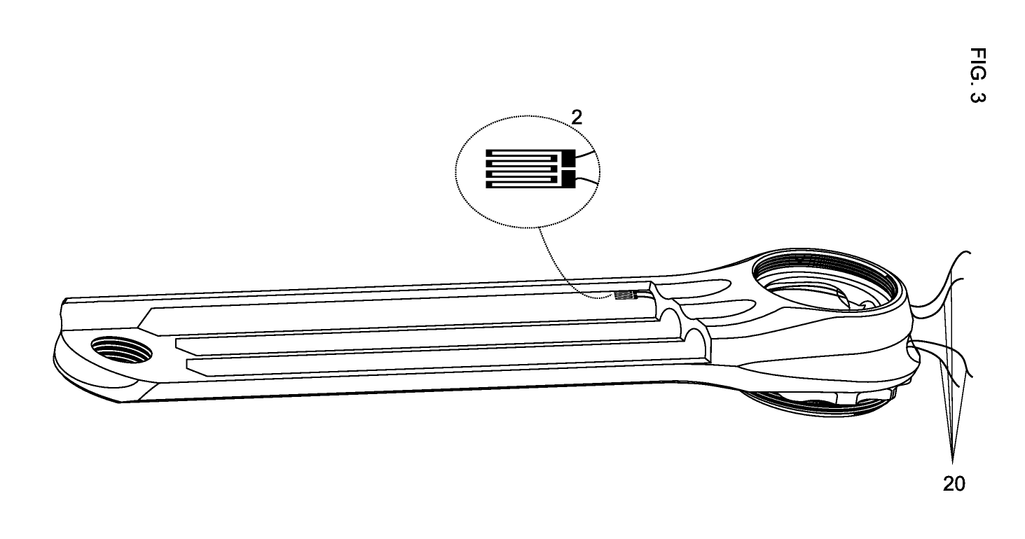

Considering a cartesian coordinate system (XYZ) as shown in FIG. 1, with origin at the intersection point between the bottom bracket axis (3) and the main longitudinal axis of the crank arm (7), and where the X axis coincides with said bottom bracket axis, and the XY plane containing the axis corresponding to the pedal (4), so that corresponds to the plane of symmetry of the crank (10). The Z axis corresponds therefore to the direction of the effective forces applied on the pedal considering the crank as a rigid-body. The main longitudinal crank arm axis (7), also called Y′, is then contained in the XY plane and practically aligned with the direction Y, though there is a certain opening angle for ergonomic reasons in order to liberate some space to avoid hits and frictions with the cyclist's ankles. Thus we may define the opening angle (12) as between the main axis Y′ (coincident with the main crank axis (7)) and the axis Y.

The layout of the gauges in both holes is as described above, such that its coordinates in X and Y are identical, but opposite values in Z. With such an arrangement they will allow to know precisely the bending moment crank arm (1) normal to the plane Y′Z. And as the opening angle (12) is small, within the range of 0 degrees to 5 degrees, we can consider that the crank bending moment in the X direction is estimated accurately by that value. In any case the measurement error will be smaller when the smaller is the torsional deformation around Y′ suffered by the crank arm (1) in the existing length from the position where the gauges (2) are located to the bottom bracket axis (3); and said deformation can be reduced by design due to the tubular construction of the arm, and by minimizing the distance between the gauges (2) and the bottom bracket axis (3).

In order for the strain gauges (2) to provide the correct deformation data, they must undergo the same deformations as the walls of the crank arm holes; therefore the fixing operation of the gauges is extremely important.

Later these gauges (2) have to be connected by electrical wiring (20) to a corresponding electronic module (30), which transforms the displacement reproduced by the gauges into an electrical signal by means of a Wheatstone bridge configuration of the gauges. Due to the symmetrical disposition of the gauges (2) inside the bicycle crank arm (1), and once electrically connected in this bridge, with opposed configuration, it is achieved that only in the case of measurements of opposite deformations will result in an output signal from the electronic module (30). So this configuration of the gauges only responds to deflections of the crank in its working direction, i.e. orthogonal to the main longitudinal axis of the crank and included in the plane of symmetry, giving null values for all the other crank efforts: traction-compression, torsion (along its longitudinal axis) and lateral deflection (normal to the plane of symmetry), obtaining directly from the electronic module (30) a linear output signal which is proportional to the value of the crank bending moment according to its working direction. And since this direction is, for the geometric nature of the cranks, practically coincident with the bottom bracket, the bending moment measured by the pedaling torque sensor device accurately approximates the torque exerted by the cyclist's leg around the bottom bracket axis (3).

This arrangement eliminates the need for further electronic corrections or computer programming which have some of the torque measuring systems included in the Prior Art, to transform the data collected by the corresponding sensors, because in the case of this pedaling torque sensor device object of the invention, said deflection value according to its working direction and therefore the torque developed by each one of the cyclist's legs, is obtained without further conversion than the necessary homothety to change the measured data values, following a previous calibration process for each particular pedaling torque sensor device, so that the deformation experienced by the gauges (2) which is translated to voltage units (millivolt) in the electronic module (30), can be translated into torque units (Newton*meters) at a power meter CPU (35) and can be displayed at a cycle computer (50) or PC.

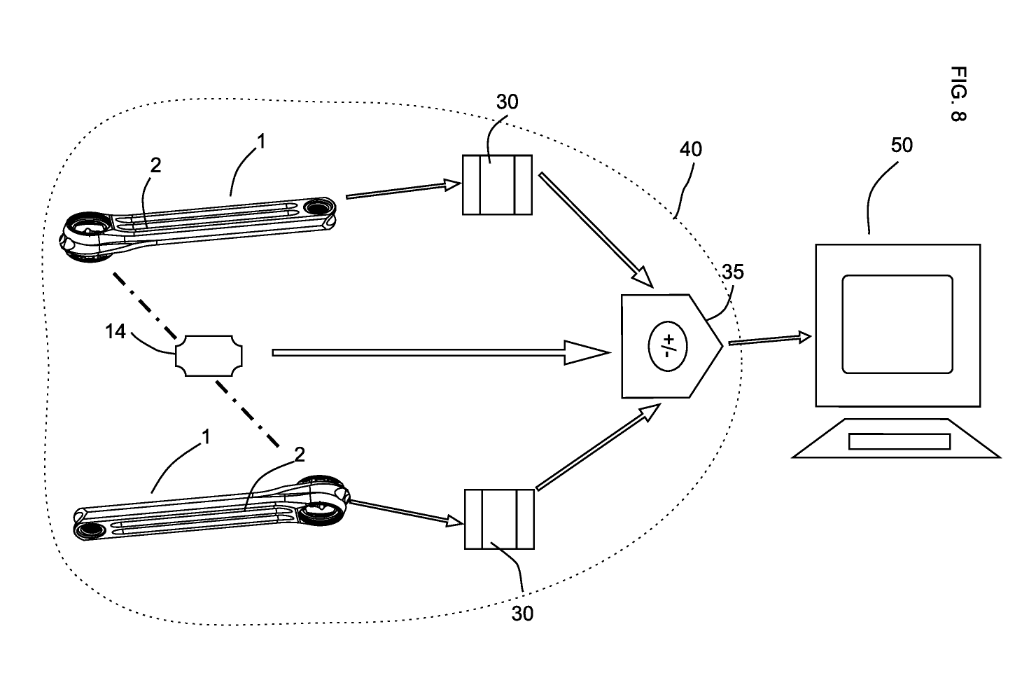

So, another aspect of the present invention is a power meter apparatus (40) shown in FIG. 8, comprising two pedaling torque sensor devices corresponding to each of two cyclist's leg, with the corresponding electronic modules (30) as described above, means for measuring or estimating the instantaneous angular velocity of the crankset and a power meter CPU (35) responsible to integrate and process the different signals received from the aforementioned sensors and means, in order to calculate jointly and separately the instantaneous power delivered for each cyclist's leg and send these data via wireless signal, enabling the user to view or save them on his monitor or cycle computer (50).

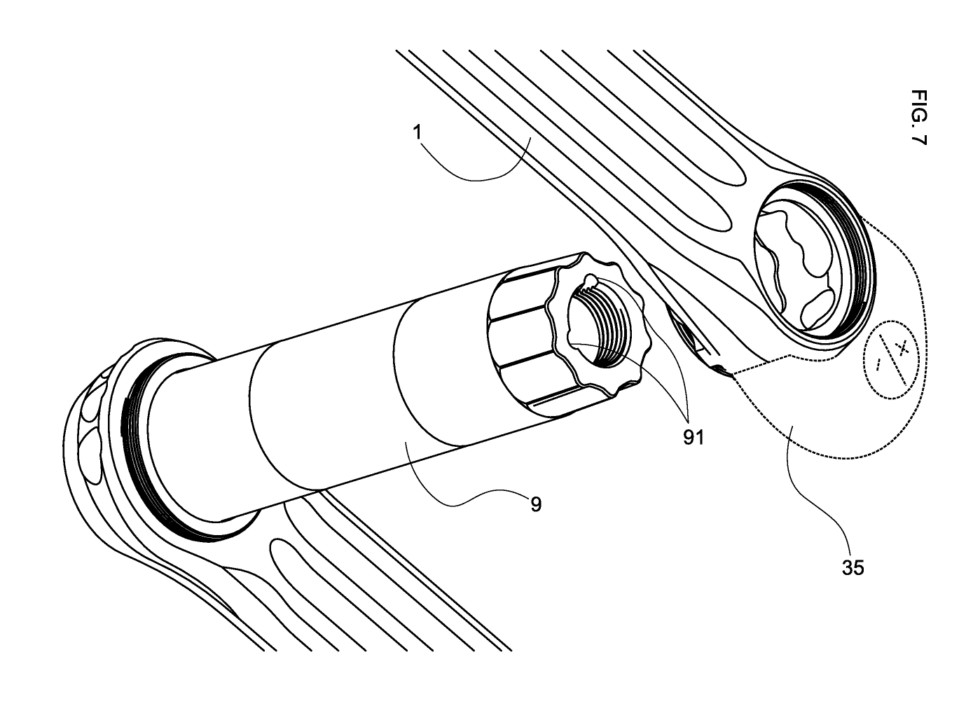

This apparatus can be arranged, among other configurations, within a waterproof housing coupled to one of the pedaling torque sensor devices as shown in FIG. 7. As much as the crankset is a rotatable component, the power meter apparatus (40) needs batteries and one or more antennas for communication between these different components: from the electronic module (30) to the power meter CPU (35), and from the power meter CPU (35) to the cycle computer (50).

The aforementioned means for measuring or estimating instantaneous angular velocity of the crankset may be based in an angular position sensor (14) of the crankset, in just a cadence sensor, in accelerometers, etc. Although the cadence could be also obtained by filtering the torque signal itself, this could lead to lower accuracy and higher electric consumption.

Moreover, this power meter CPU (35) processes the information of the angular position sensor (14) synchronously with the received signals from each of the pedaling torque sensor devices, obtaining the power distribution per leg depending on the angular position of the crankset. Then the power meter apparatus (40) sends this information, usually through wireless technology, to a computer or cycle computer (50), for further analysis and displaying to the user: cyclist, coach, sport director or scientist.

This not only enables the power meter apparatus (40) to calculate the BALANCE LEFT-RIGHT ratio but also the BALANCE PUSH-PULL ratio, furthermore enabling to have this balance percentage for each leg and/or for both overall.

### OTHER EMBODIMENTS

Structurally, the pedaling torque sensor device comprising a crank arm (1) which can also have a central drill hole (13) longitudinally executed within said crank arm (1) from its end corresponding to the bottom bracket axis (3), whose longitudinal axis coincides with the main longitudinal axis (7) of the crank arm, which makes it lightweight, but can also be used, on one side to accommodate some other sensor such as an accelerometer or even some components of the power meter apparatus (40), and secondly to help structurally setting a support for the power meter CPU (35), coupled on the outside.

This crank arm may have a greater number of strain gauges (2) in order to improve the torque measurement accuracy, and to obtain other secondary data as the torsional moment (in the axis Y′), the lateral bending (in the XY plane) or the traction-compression of the crank arm, which would help us to improve some other aspects of the ergonomics cycling. In this case the power meter CPU (35) would be more complex and the power consumption would be higher.

In another embodiment of the pedaling power meter apparatus (40), the power meter CPU (35) can be structurally attached to one of both pedaling torque sensor devices integrating its corresponding electronic module (30), while the connection to the other electronic module (30) corresponding to the other pedaling torque sensor device is performed via wireless communication.

Being the bottom bracket spindle (9) structurally joined with both pedaling torque sensor devices, we can arrange wiring connections through inside the bottom bracket spindle. So we propose another embodiment integrating both corresponding electronic modules (30) into the power meter CPU (35) housed for example, inside the bottom bracket spindle (9), where it would have room enough for its location including electrical wiring connectors. We also may house the power meter CPU (35) structurally attached to one of both pedaling torque sensor devices. Because the wiring connection from the gauges is arranged through the bottom bracket spindle, the only disadvantage is that, it is up to the end user to disconnect the electrical wiring (20) while performing the disassembly of the crankset in case of mechanical maintenance or just removing from the bike. In this layout, using wiring connection through inside the bottom bracket spindle (9), this spindle has disposed grooves (91) inside thereof, in order to allow the electrical wiring (20) going into said spindle avoiding the closure configured by the screws which ensure the structural fixation of the crank set.

In another embodiment, the power meter CPU (35) would be coupled to the bicycle frame, being both pedaling torque sensor devices aforementioned connected via wireless signal. So we would move a significant portion of the electricity consumption to a non structural bicycle component, easy to remove for the user when required to recharge or even for downloading data from a memory module provided to the power meter CPU for this purpose.

Finally, due to the interest many cyclists have to train the rising phase of the pedal, in order to detect if the leg is actually working during the rising phase of the pedal and thus to correct the pedaling technique, we propose an added computing utility being implemented within the power meter CPU (35) or in the cycle computer (50). This utility consists in a warning mode by means of sound alerts or beeps, optionally activated by the cyclist: when this utility detects from one of the cyclist's legs a negative torque, it produces a warning signal which may even be different for each leg.

1) A pedaling torque sensor device for any single cyclist's leg, also referred as torque sensor crank arm, comprising a bicycle crank arm (1) with some strain gauges (2) attached to it with the purpose of measuring the bending moment of the crank arm in the direction of the bottom bracket axis (3), being these gauges wiring (20) connected to an electronic module (30) able to send measured deflexion data to a power meter CPU (35), characterized in that said crank arm (1) has a plane of symmetry (10) containing the bottom bracket axis (3) and the pedal axis (4), having at least two straight holes (5, 6) respectively symmetric about said plane of symmetry (10), executed just at the end of the crank arm corresponding to the bottom bracket axis (3) so that these holes configure longitudinal cavities inside said crank arm (1), and so that said strain gauges (2) are fixed on the inside of the crank arm (1) within said holes (5.6) having a symmetrical arrangement with respect to said plane of symmetry (10).

2) A pedaling torque sensor device according to claim 1, characterized in that the cross section of said crank arm (1) is also symmetric with respect to the plane, containing the main longitudinal axis of the crank arm (7), which is orthogonal to said plane of symmetry (10).

3) A pedaling torque sensor device according to one of claims 1 to 2, characterized in that said straight holes (5, 6) are drilled.

4) A pedaling torque sensor device according to one of claims 1 to 3, characterized by having a central straight drill hole (13), longitudinally executed within the crank arm (1) from its end corresponding to the bottom bracket (3), whose longitudinal axis coincides with the main longitudinal axis (7) of the crank arm.

5) A pedaling power meter apparatus (40), comprising one torque sensor per leg, means to measure or estimate the instantaneous angular velocity of the crankset and a power meter CPU (35) responsible to integrate and process the different signals received from the aforementioned sensors and means; being the power meter apparatus (40) function to calculate jointly and separately the instantaneous power delivered per leg and send these data via wireless enabling the user to view or save them on his monitor or cycle computer (50),
characterized in that each one of those two torque sensors is a pedaling torque sensor device according to one of claims 1 to 4.

6) A pedaling power meter apparatus (40) according to claim 5, characterized by incorporating a computing utility that calculates and sends data to the cycle computer (50) in order to display both the working balance ratio comparing both legs, referred as BALANCE LEFT-RIGHT, and the working balance ratio comparing the pedaling downstroke phase with the pedal raising, referred as BALANCE PUSH-PULL, providing a balance for each leg and/or one for both overall.

7) A pedaling power meter apparatus (40) according to one of claims 5 to 6, characterized by incorporating a computing utility for pedaling technique training, optionally activated by the cyclist, that generates a warning sound signal whenever this utility detects a negative torque application in one of the rider's legs.

8) A pedaling power meter apparatus (40) according to one of claims 5 to 7, characterized in that the power meter CPU (35) is structurally attached to one of both torque sensor crank arms (1) integrating its corresponding electronic module (30), while the connection to the other electronic module (30) corresponding to the other torque sensor crank arm (1) is performed via wireless communication.

9) A pedaling power meter apparatus (40) according to one of claims 5 to 7, characterized in that the power meter CPU (35) integrates both electronic modules (30), which are wiring (20) connected to the corresponding gauges (2) in both torque sensor crank arms (1), being said electrical wiring (20) arranged through inside the bottom bracket spindle (9) which has for this purpose some grooves (91) inside thereof, in order to allow said electrical wiring (20) going into said spindle avoiding the closure configured by the screws which ensure the structural fixation of the crank set.

10) A pedaling power meter apparatus (40) according to claim 9, characterized in that the power meter CPU (35) is structurally attached inside the bottom bracket spindle (9).

11) A pedaling power meter apparatus (40) according to claim 9, characterized in that the power meter CPU (35) is structurally attached to one of both torque sensor crank arms.

12) A pedaling power meter apparatus (40) according to one of claims 5 to 7, characterized in that the power meter CPU (35) is structurally located independent of both torque sensor crank arms (1), attached in the bike frame being connected to the electronic modules (30) of both torque sensor crank arms (1) via wireless communication.
